(19) United States
(12) Patent Application Publication
(10) Pub. No.: US 2011/0185420 A1
(43) Pub. Date: Jul. 28, 2011

(54) DETECTION METHODS AND DEVICES OF WEB MIMICRY ATTACKS

(75) Inventors: Hahn-Ming LEE, Taipei city (TW); En-Sih LIOU, Taipei City (TW); Jerome YEH, Taipei City (TW); Ching-Hao MAO, Taipei City (TW)

(73) Assignee: NATIONAL TAIWAN UNIVERSITY OF SCIENCE & TECHNOLOGY, Taipei city (TW)

(21) Appl. No.: 12/820,564

(22) Filed: Jun. 22, 2010

(30) Foreign Application Priority Data
Jan. 26, 2010 (TW) 099102049

(51) Int. Cl. G06F 11/00

(52) U.S. Cl. 726/22

(57) ABSTRACT

A web mimicry attack detection device is provided, including: a first token sequence collector receiving a hypertext transfer protocol request and extracting string content of the hypertext transfer protocol request according to a token collection method to generate a token sequence corresponding to the hypertext transfer protocol request, wherein the token sequence comprises a plurality of the tokens; and a mimicry attack detector generating a label and a confidence score corresponding individually to the tokens according to the tokens and a conditional random field probability model, summing the confidence score individually corresponding to the tokens in the token sequence by a summary rule to generate a summary confidence score, and determining whether the hypertext transfer protocol request is an attack according to the summary confidence score and the label individually corresponding to the tokens.

### CROSS REFERENCE TO RELATED APPLICATIONS

This application claims priority of Taiwan Patent Application No. 099102049 filed on Jan. 26, 2010, the entirety of which is incorporated by reference herein.

### BACKGROUND OF THE INVENTION

1. Technical Field

The invention relates to web mimicry attacks, and more particularly, to detection methods and devices for detecting web mimicry attacks.

2. Related Art

Presently, web sites are being developed to provide many application programs in order to provide diversified application services. However, this may make web servers more at a risk for malicious attacks.

Most web application attacks use scripts, wherein web attacks are created with variation and flexibility for when the attack occurs. This worsens web mimicry attacks. As for web mimicry attacks, it is a variable method, wherein hackers may gain access to web sites. Basically, a web intrusion detection system is tricked into deeming that a web mimicry attack is a normal action instead of a web mimicry attack. Thus, no detection is observed, and through the web mimicry attack, hackers may access web sites to manipulate, steal or maliciously attack the web sites.

The conventional web intrusion detection method is based on characters which detect web attacks. However, web mimicry attacks are made more easily due to the conventional web intrusion detection methods. Following, tokens were used in replace of characters, wherein a hypertext transfer protocol request is segmented to a token sequence and a model of normal actions is constructed for detecting attacks. However, the conventional method does not completely consider the probability of correlation among adjacent tokens.

Therefore, web mimicry attack detection methods and devices for effectively modeling correlation of adjacent tokens are desired.

### BRIEF SUMMARY OF THE INVENTION

One aspect of the present invention is to provide a web mimicry attack detection device, comprising: a first token sequence collector receiving a hypertext transfer protocol request and extracting string content of the hypertext transfer protocol request according to a token collection method to generate a token sequence corresponding to the hypertext transfer protocol request, wherein the token sequence comprises a plurality of the tokens; and a mimicry attack detector generating a label and a confidence score corresponding individually to the tokens according to the tokens and a conditional random field probability model, summing the confidence score individually corresponding to the tokens in the token sequence by a summary rule to generate a summary confidence score, and determining whether the hypertext transfer protocol request is an attack according to the summary confidence score and the label individually corresponding to the tokens.

Another aspect of the present invention is to provide a web mimicry attack detection method, comprising: constructing a conditional random field probability model; receiving a hypertext transfer protocol request by a first token sequence collector; extracting string content of the hypertext transfer protocol request according to a token collection method to generate a token sequence corresponding to the hypertext transfer protocol request, wherein the token sequence comprises a plurality of the tokens; generating a label and a confidence score corresponding individually to the tokens according to the tokens and a conditional random field probability model; summing the confidence score individually corresponding to the tokens in the token sequence by a summary rule to generate a summary confidence score; and determining whether the hypertext transfer protocol request is an attack according to the summary confidence score and the label individually corresponding to the tokens.

The advantage and spirit of the application will be better understood by the following recitations and the appended drawings.

### BRIEF DESCRIPTION OF DRAWINGS

The application can be more fully understood by reading the subsequent detailed description and examples with references made to the accompanying drawings, wherein:

FIG. 1 is a block diagram illustrating a web mimicry attack detection device 10 for detecting web mimicry attacks according to an embodiment of the present invention.

FIG. 2 is an example illustrating a hypertext transfer protocol request and a token sequence corresponding to the hypertext transfer protocol request according to an embodiment of the present invention.

FIG. 3 is a schematic diagram illustrating a token sequence and a label sequence corresponding to the token sequence according to an embodiment of the present invention.

FIG. 4-1 is a block diagram illustrating a first token sequence collector 102 according to an embodiment of the present invention.

FIG. 4-2 is a block diagram illustrating a second token sequence collector 1012 according to an embodiment of the present invention.

FIG. 5-1 is an example illustrating a decision method of the web mimicry attack detector 103 according to an embodiment of the present invention.

FIG. 5-2 is another example illustrating a decision method of the web mimicry attack detector 103 according to an embodiment of the present invention.

FIG. 6 is a flow chat illustrating a web mimicry attack detection method 6 according to an embodiment of the present invention, wherein the web mimicry attack detection method 6 comprises a conditional random field probability model construction step S60 and a detection step S61.

FIG. 7 is a flow chat illustrating a conditional random field probability model construction step S60 according to an embodiment of the present invention.

FIG. 8 is a flow chat illustrating a detection step S61 according to an embodiment of the present invention.

### DETAILED DESCRIPTION

The following description is of the best-contemplated mode of carrying out the invention. This description is made for the purpose of illustrating the general principles of the invention and should not be taken in a limiting sense. The scope of the invention is best determined by reference to the appended claims.

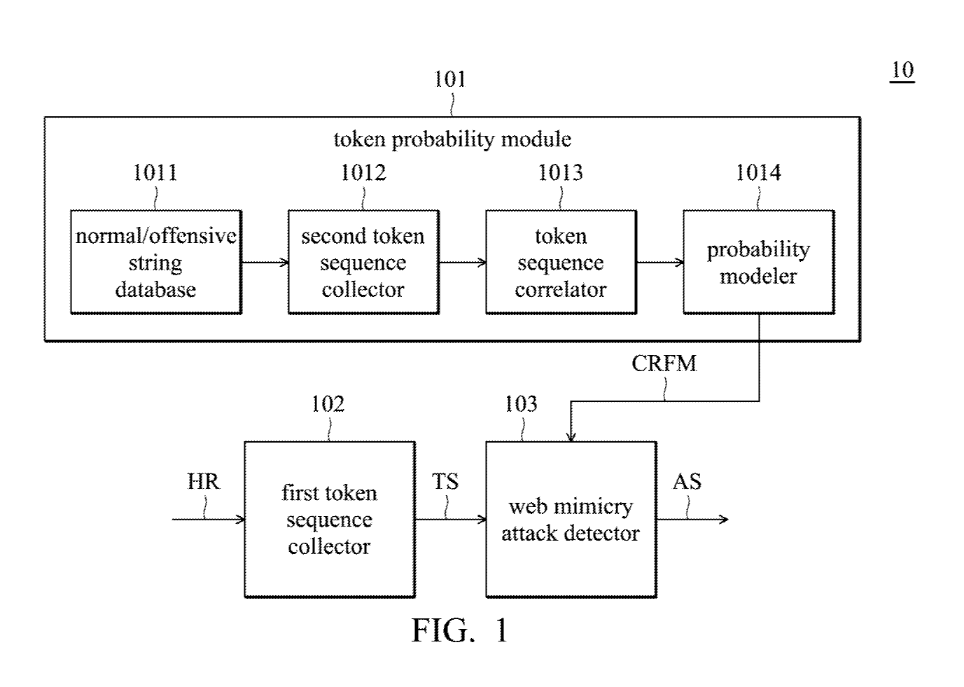

FIG. 1 is a block diagram illustrating a web mimicry attack detection device 10 for detecting web mimicry attacks according to an embodiment of the present invention. The web mimicry attack detection device comprises a token probability module 101, a first token sequence collector 102 and a web mimicry attack detector 103.

The first token sequence collector 102 in the web mimicry attack detection device 10 receives a hypertext transfer protocol request HR and extracts string content of the hypertext transfer protocol request HR according to a token collection method to generate a token sequence TS corresponding to the hypertext transfer protocol request HR, wherein the token sequence TS comprises a plurality of the tokens.

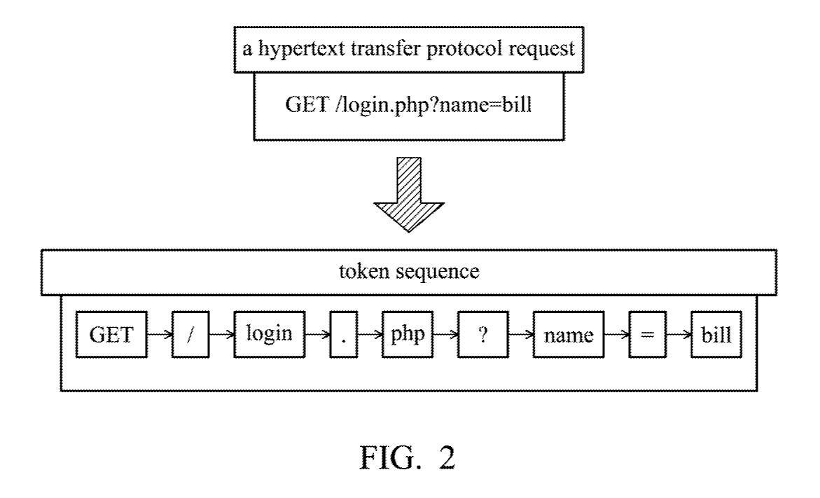

As shown in the FIG. 2, the first token sequence collector 102 receives the string content of the hypertext transfer protocol request, “GET /login.php?name=bill”. The string content of the hypertext transfer protocol request, “GET /login.php?name=bill”, is segmented into a plurality of the tokens according to the token collection method, wherein the string content of the hypertext transfer protocol request, “GET /login.php?name=bill”, is segmented into a plurality of the tokens from left to right according to a rule which is defined, wherein a token must be a the special symbol or a string composed of alphabets and digits, and then the token sequence in the FIG. 2 is generated according to locations of the tokens from left to right in the hypertext transfer protocol request.

The web mimicry attacks detector 103 in the web mimicry attack detection device 10 generates a label and a confidence score corresponding individually to the tokens according to the all tokens of the token sequence TS and a conditional random field probability model CRFM generated by the token probability module 101, and sums the confidence score individually corresponding to the tokens in the token sequence TS by a summary rule to generate a summary confidence score. Next, the web mimicry attacks detector 103 determines whether the hypertext transfer protocol request is an attack or not according to the summary confidence score and the label individually corresponding to the tokens.

For example, the web mimicry attacks detector 103 receives a hypertext transfer protocol request and a token sequence as shown in FIG. 2. FIG. 2 is an example illustrating a hypertext transfer protocol request and a token sequence corresponding to the hypertext transfer protocol request according to an embodiment of the present application. The string content of the hypertext transfer protocol request is “GET /login.php?name=bill”. The string content of the hypertext transfer protocol request, “GET /login.php?name=bill”, is segmented into a plurality of the tokens according to token collection method, wherein the token sequence comprises the plurality of the tokens.

In the token sequence shown in the FIG. 2, every string or character in a rectangular frame represents a token. The token collection method uses special symbols shown in the Table 1 to delimit the boundary of the tokens. In other words, the special symbols shown in the Table 1 represent that the symbols in the boundary of the token. Table 1 is shown below.

TABLE 1

| | | | | | |
|---|---|---|---|---|---|
| @ | [ | ] | \ | $ | ′ |
| ~ | < | \grave{ } | \hat{ } | “ | = |
| - | , | / | . | { | } |
| & | : | % | ; | ! | * |
| ‘ | ) | # | ( | \| | > |
| ? | + | | | | |

Therefore, as shown in the FIG. 2, the symbols “/”, “.”, “?” and “=” in the string content of the hypertext transfer protocol request, “GET /login.php?name=bill”, are used to delimit the boundary of the token. Thus, the hypertext transfer protocol request, “GET /login.php?name=bill”, is segmented into the plurality of the tokens, “GET”, “/”, “login”, “.”, “php”, “?”, “name”, “=” and “bill” (from right to left).

The web mimicry attacks detector 103 determines a label and a confidence score for every one of the tokens in the token sequence according to the conditional random field probability model CRFM generated by the token probability module 101, wherein the label corresponding individually to the tokens is a normal or offensive classification name.

For example, the web mimicry attacks detector 103 determines a label “A1” and a confidence score “0.6” for the first token in the token sequence according to the conditional random field probability model CRFM, wherein the label “A1” and the confidence score “0.6” represent that the probability that the first token is a first type of attack is 60%.

For another example, the web mimicry attack detector 103 determines a label “A2” and a confidence score “0.4” for the second token in the token sequence according to the conditional random field probability model CRFM, wherein the label “A2” and the confidence score “0.4” represent that the probability that the second token is a second type of attack is 40% and so on. The label “N” and the labels “A1”˜“A7” represent offensive classification names. For example, the label “A1” represents that a first type of attack and the label “A2” represents that a second type of attack and so on. The invention does not only limit the first to seventh type of attacks. A person skilled in the art can determine the classification of the network attack according to practical requirements.

Therefore, the web mimicry attacks detector 103 determines a label and a confidence score for every one of the tokens in the token sequence according to the conditional random field probability model CRFM, and then determines whether the hypertext transfer protocol request HR is an attack and the type of attack of attack according to the label individually corresponding to the tokens and the summary confidence score summed by all confidence scores. The attack warning signal AS is output, wherein the attack warning signal AS indicates the type of attack of the hypertext transfer protocol request HR when the hypertext transfer protocol request is determined to be an attack.

The conditional random field probability model CRFM is generated by the token probability module 101. The token probability module 101 in the web mimicry attack detection device 10 comprises a normal/offensive string database 1011, a second token sequence collector 1012, a token sequence correlator 1013 and a probability modeler 1014.

The normal/offensive string database 1011 stores normal string data NSD and offensive string data ASD, wherein the normal string data NSD and the offensive string data ASD are first defined by experts and the normal string data NSD and the offensive string data ASD are used to construct the conditional random field probability model CRFM by the token probability module 101.

The second token sequence collector 1012 extracts the normal string data NSD and the offensive string data ASD according to the token collection method to generate a normal token sequence NTS corresponding to the normal string data NSD and a offensive token sequence ATS corresponding to the offensive string data ASD, wherein the token collection rule is defined, wherein a token must be a the special symbol or a string composed of alphabets and digits.

The token sequence correlator 1013 calculates probabilities of adjacent token correlations in the normal token sequence NTS and probabilities of adjacent token correlations in the offensive token sequence ATS, and then constructs an adjacent token correlations probability table to generate a plurality of model parameters.

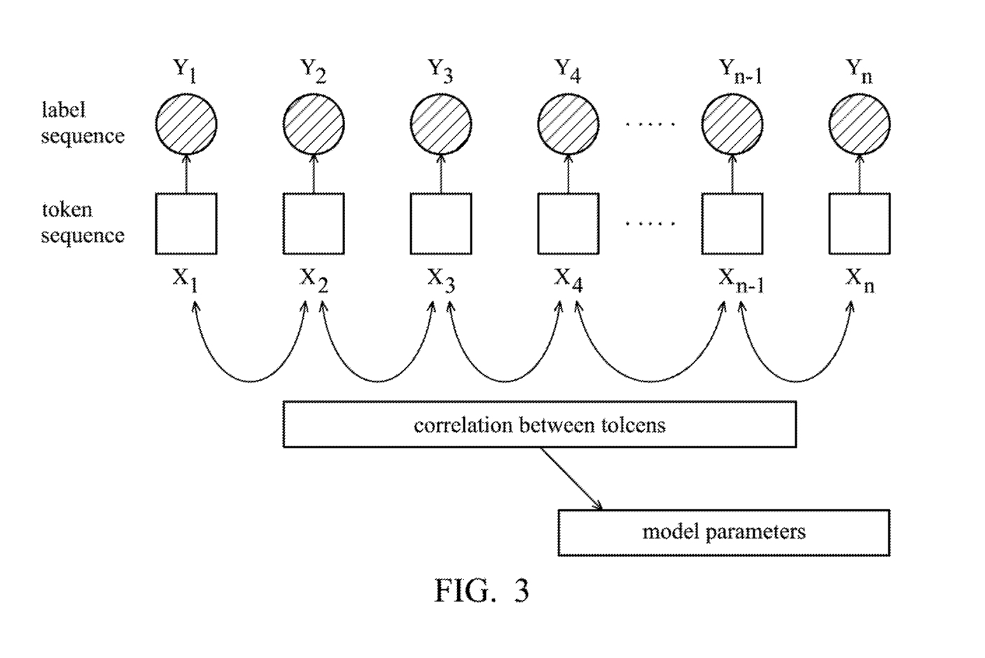

The probability modeler 1014 constructs the conditional random field probability model CRFM according to the model parameters. As shown in the FIG. 3, the probabilities of adjacent token correlations in the normal token sequence NTS and the probabilities of adjacent token correlations in the offensive token sequence ATS are gathered by statistics. In other words, the probabilities of the correlation of the adjacent tokens in the token sequence are gathered by statistics.

For example, the appearance probability of the token x₁ in front of the token x₂ and the appearance probability of the token x₃ in back of the token x₂ are gathered by statistics in the given of the token x₂. The adjacent token correlations probability table is constructed by considering the appearance probability of the correlation between the front token and the back token in sequence of every token in the token sequence. And then the model parameters are generated according to the adjacent token correlations probability table.

FIG. 3 is a schematic diagram illustrating a token sequence and a label sequence corresponding to the token sequence according to an embodiment of the present application. The token x₁, the token x₂ . . . and the token xₙ have a corresponding label, respectively, wherein a label corresponding to token x₁ is the label y₁ and a label corresponding to token x₂ is the label y₂ and so on. The adjacent token correlations probability table is generated according to the appearance correlation between the tokens.

For example, the appearance probability of the token x₁ in front of the token x₂ and the appearance probability of the token x₃ in back of the token x₂ are gathered by statistics in the given of the appearance probability of the token x₂. The appearance probability of the token x₂ in front of the token x₃ and the appearance probability of the token x₄ in back of the token x₃ are gathered by statistics in the given of the appearance probability of the token x₃. The appearance probability of the token x₂ in back of the token x₁ is gathered by statistics in the given of the appearance probability of the token x₁.

Therefore, the adjacent token correlations probability table is generated by gathering the token correlation of every token in the normal token sequence NTS corresponding to the normal string data NSD and offensive token sequence ATS corresponding to the offensive string data ASD by statistics. And then the model parameters are generated according to the adjacent token correlations probability table.

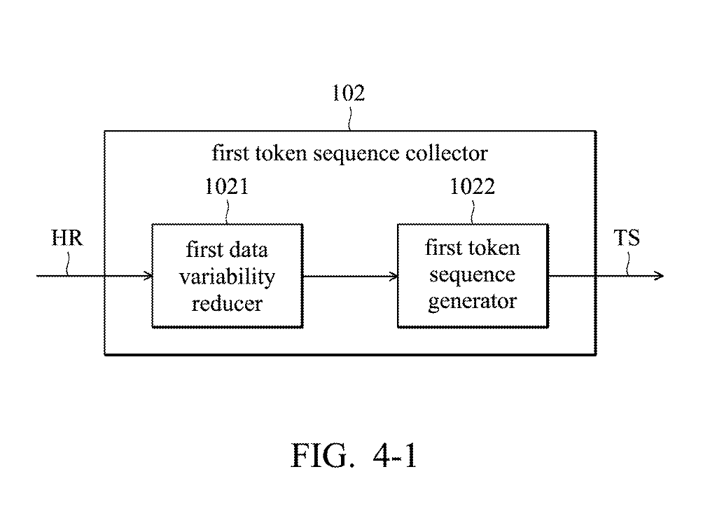

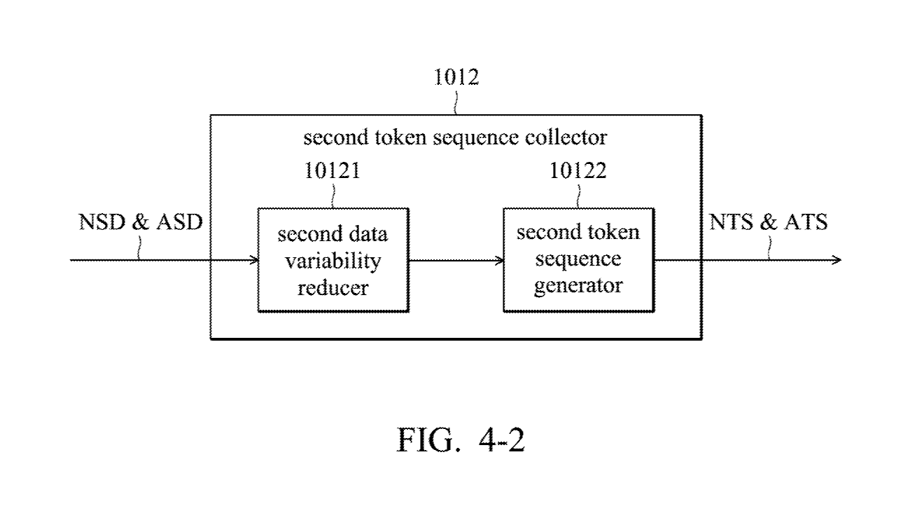

FIG. 4-1 is a block diagram illustrating a first token sequence collector 102 according to an embodiment of the present application. The first token sequence collector 102 comprises a first data variability reducer 1021 and a first token sequence generator 1022.

The first data variability reducer 1021 punches the string content of the hypertext transfer protocol request HR by decoding strings, canceling repetitions and adding white space, and rewriting all letters of the string with lower case letters. The first token sequence generator 1022 extracts the punched string content of the hypertext transfer protocol request HR according to the token collection method to generate the token sequence TS corresponding to the hypertext transfer protocol request HR.

FIG. 4-2 is a block diagram illustrating a second token sequence collector 1012 according to an embodiment of the present application. The second token sequence collector 1012 comprises a second data variability reducer 10121 and a second token sequence generator 10122.

The second data variability reducer 10121 punches the string content of the normal string data NSD and the offensive string data ASD by decoding strings, canceling repetitions and adding white space, and rewriting all letters of the string with lower case letters. The second token sequence generator 10122 extracts the punched string content of the normal string data NSD and the offensive string data ASD according to the token collection method to generate the normal token sequence NTS corresponding to the normal string data NSD and offensive token sequence ATS corresponding to the offensive string data ASD.

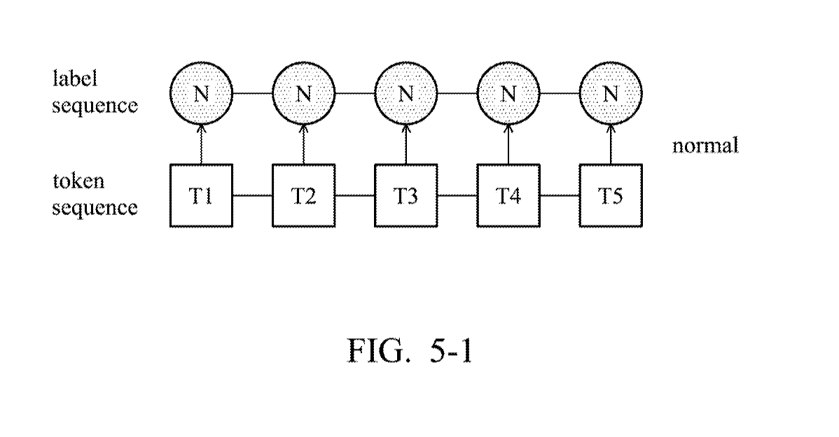

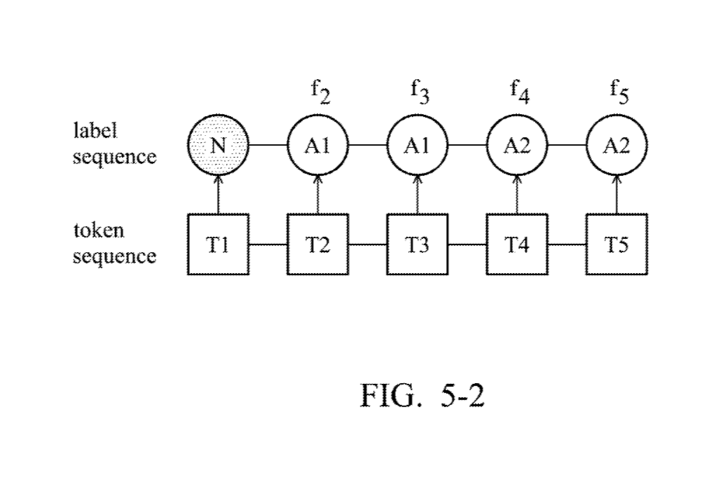

FIG. 5-1 is an example illustrating a decision method of the web mimicry attacks detector 103 according to an embodiment of the present application. As shown in the FIG. 5-1, the token sequence corresponding to the hypertext transfer protocol request is composed of the token T1, the token T2, the token T3, the token T4 and the token T5 (from right to left). Every token, the token T1˜T5, corresponds to a label “N”, wherein the label N represents that the token corresponding to the label “N” is normal. The web mimicry attacks detector 103 determines that the token sequence shown in the FIG. 5-1 is a normal token sequence. In other words, the hypertext transfer protocol request also is a normal hypertext transfer protocol request.

It is noteworthy that if the label corresponding to any token in the token sequence belongs to any type of attack, the hypertext transfer protocol request is determined to be an attack. In other words, the hypertext transfer protocol request also is a normal hypertext transfer protocol request, when the labels corresponding to tokens in the token sequence all correspond to the label “N”.

FIG. 5-2 is another example illustrating a decision method of the web mimicry attacks detector 103 according to an embodiment of the present application. As shown in the FIG. 5-2, the token sequence corresponding to the hypertext transfer protocol request is composed of the token T1, the token T2, the token T3, the token T4 and the token T5 (from right to left).

The token T1 corresponds to a label “N”, the token T2 corresponds to a label “A1” and a confidence score “f2”, the token T3 corresponds to a label “A1” and a confidence score “f3”, the token T4 corresponds to a label “A2” and a confidence score “f4” and the token T5 corresponds to a label “A2” and a confidence score “f5”. The label “N” represents that the token corresponding to the label “N” is normal. The label “A1” represents that the token corresponding to the label “A1” is a first type of attack and the label “A2” represents that the token corresponding to the label “A2” is a second type of attack. The confidence score is the probability that the token belongs to a first type of attack or the probability that the token belongs to a second type of attack.

The web mimicry attacks detector 103 determines that the token sequence belongs to a type of attack according to all of the labels and all of the confidence scores corresponding to the tokens in the token sequence. For example, as shown in the FIG. 5-2, the token T1 is normal, the token T2 and the token T3 are a first type of attack, and the token T4 and the token T5 are a second type of attack because the labels of the token T2 and the token T3 are marked “A1” and the labels of the token T4 and the token T5 are marked “A2”.

According to all confidence scores corresponding to the tokens in the token sequence, the confidence score “f2” and the confidence score “f3” belong to a first type of attack and the confidence score “f4” and the confidence score “f5” belong to a second type of attack. Therefore, the total confidence score in which the token sequence belongs to a first type of attack is f2+f3 and the total confidence score in which the token sequence belongs to a second type of attack is f4+f5. The web mimicry attack detector 103 determines that the token sequence belongs to a first type of attack when f2+f3>f4+f5, the web mimicry attack detector 103 determines that the token sequence belongs to a second type of attack when f4+f5>f2+f3, and the web mimicry attack detector 103 determines that the token sequence belongs to a first type of attack and a second type of attack when f2+f3=f4+f5. However, a person skilled in the art knows that the condition. f2+f3=f4+f5, may not occur.

In another example, the web mimicry attacks detector 103 determines that the token sequence belongs to a type of attack according to the number of appearance time of the labels, and then according to the confidence scores when the number of times of the different labels is the same. For example, in a token sequence, the web mimicry attacks detector 103 determines that the token sequence belongs to a first type of attack, when the number of appearance time of the label “A1” is the largest among other labels.

The web mimicry attacks detector 103 determines that the token sequence belongs to a type of attack according to all of the total confidence scores when the number of times of the different labels is the same. For example, in a token sequence, the web mimicry attacks detector 103 determines that the token sequence belongs to the type of attack according to the sum of the confidence scores corresponding to the label “A1” and the sum of the confidence scores corresponding to the label “A2”, when the number of times of the label “A1” and the number of appearance time of the label “A2” are simultaneously the same and largest among other labels. The web mimicry attack detector 103 determines that the token sequence belongs to first type of attack when the sum of the confidence scores corresponding to the label “A1” is larger than the sum of the confidence scores corresponding to the label “A2”, and the web mimicry attacks detector 103 determines that the token sequence belongs to a second type of attack when the sum of the confidence scores corresponding to the label “A1” is smaller than the sum of the confidence cores corresponding to the label “A2”. Note that the invention is not limited to the comparing order of the labels and the confidence scores or the comparing order of the labels and the weighted confidence scores.

Therefore, the web mimicry attacks detector 103 determines that the hypertext transfer protocol request is normal or belongs to the type of attack of attack according to every label and every confidence score corresponding to the token sequence.

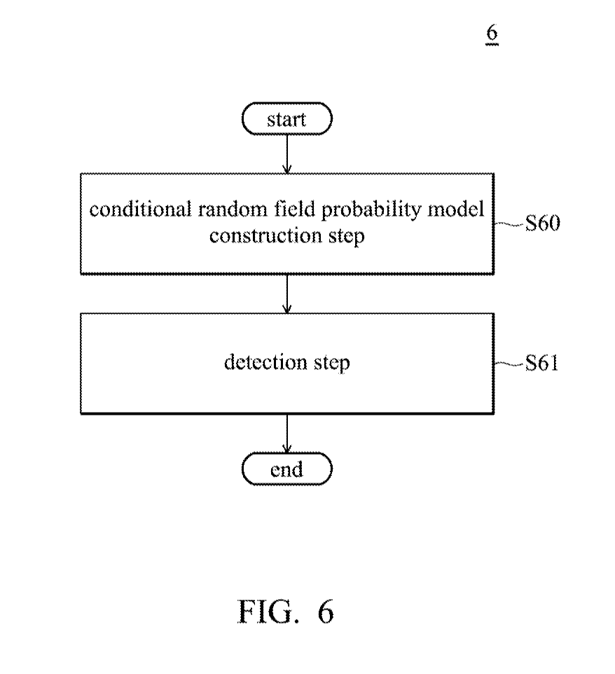

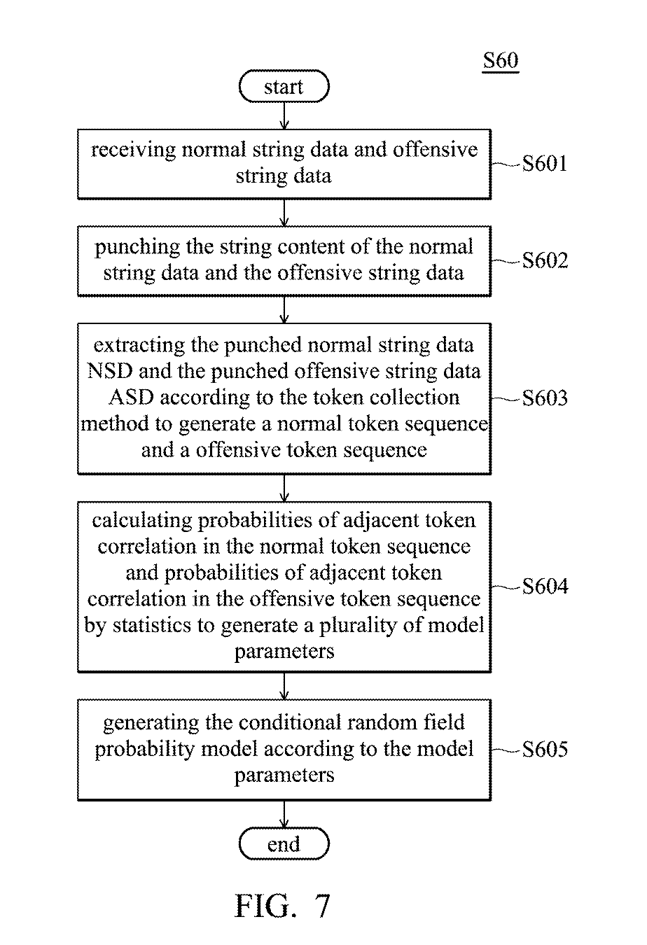

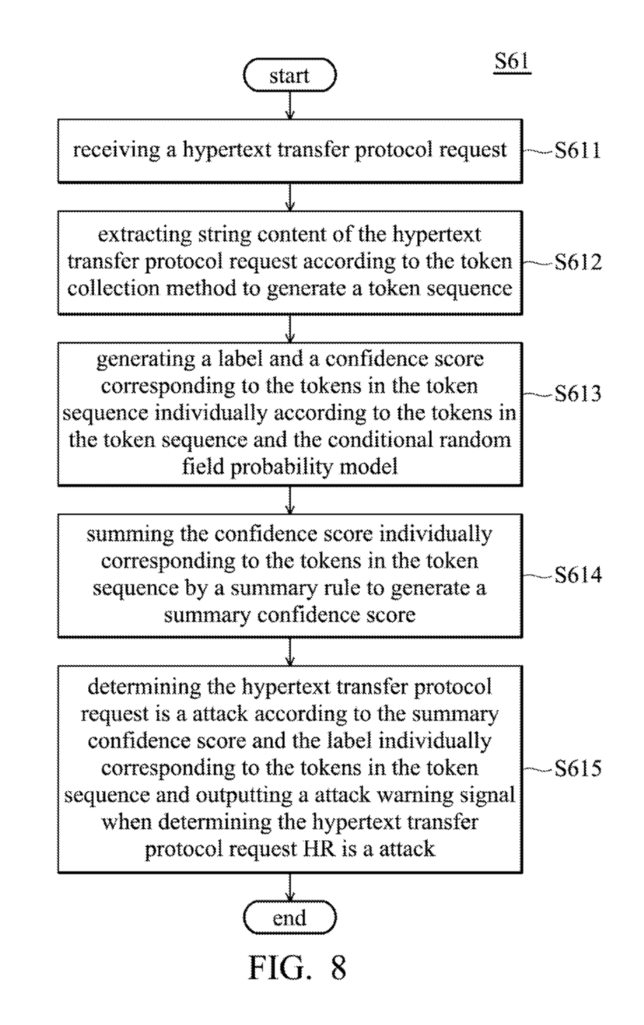

FIG. 6 is a flow chat illustrating a web mimicry attack detection method 6 according to an embodiment of the present application, wherein the web mimicry attack detection method 6 comprises a conditional random field probability model construction step S60 and a detection step S61. The conditional random field probability model construction step S60 and the detection step S61 are described with reference to FIG. 7 and FIG. 8, respectively.

FIG. 7 is a flow chat illustrating a conditional random field probability model construction step S60 according to an embodiment of the present application. The conditional random field probability model construction step S60 comprises: receiving normal string data NSD and offensive string data ASD (step S601); punching the string content of the normal string data NSD and the offensive string data ASD by decoding strings, canceling repetitions and adding white space, and rewriting all letters of the string with lower case letters (step S602); extracting the punched normal string data NSD and the punched offensive string data ASD according to the token collection method to generate a normal token sequence NTS corresponding to the punched normal string data NSD and a offensive token sequence ATS corresponding to the punched offensive string data ASD, wherein the token collection method is defined as a rule that a token must be a special symbol or a string composed of alphabets and digits; calculating probabilities of adjacent token correlations in the normal token sequence NTS and probabilities of adjacent token correlations in the offensive token sequence ATS, and constructing an adjacent token correlations probability table to generate a plurality of model parameters (step S604); and generating the conditional random field probability model CRFM according to the model parameters (step S605). The flow chat then ends.

FIG. 8 is a flow chat illustrating a detection step S61 according to an embodiment of the present application. When the conditional random field probability model CRFM has been constructed, it is detected whether a new hypertext transfer protocol request HR is an attack.

The detection step S61 comprises: receiving a hypertext transfer protocol request HR by the first token sequence collector in step S611; extracting string content of the hypertext transfer protocol request HR according to the token collection method to generate a token sequence TS corresponding to the hypertext transfer protocol request HR in step S612, wherein the token sequence TS comprises a plurality of the tokens; generating a label and a confidence score corresponding individually to the tokens according to the conditional random field probability model CRFM generated by the token probability module 101 (step S613); in step S614, summing the confidence score individually corresponding to the tokens in the token sequence TS by a summary rule to generate a summary confidence score; and in step S615, determining whether the hypertext transfer protocol request HR is an attack according to the summary confidence score and the label individually corresponding to the tokens in the token sequence TS and outputting an attack warning signal AS when determining that the hypertext transfer protocol request HR is an attack.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A web mimicry attack detection device, comprising:
a first token sequence collector receiving a hypertext transfer protocol request and extracting string content of the hypertext transfer protocol request according to a token collection method to generate a token sequence corresponding to the hypertext transfer protocol request, wherein the token sequence comprises a plurality of the tokens; and
a mimicry attack detector generating a label and a confidence score corresponding individually to the tokens according to the tokens and a conditional random field probability model, summing the confidence score individually corresponding to the tokens in the token sequence by a summary rule to generate a summary confidence score, and determining whether the hypertext transfer protocol request is an attack according to the summary confidence score and the label individually corresponding to the tokens.

2. The web mimicry attack detection device of claim 1, wherein the conditional random field probability model is generated by a token probability module.

3. The web mimicry attack detection device of claim 2, wherein the token probability module comprises:
a normal/offensive string database storing normal string data and offensive string data;
a second token sequence collector extracting the normal string data and the offensive string data according to the token collection method to generate a normal token sequence corresponding to the normal string data and a offensive token sequence corresponding to the offensive string data;
a token sequence correlator calculating probabilities of adjacent token correlations in the normal token sequence and probabilities of adjacent token correlations in the offensive token sequence, and constructing an adjacent token correlations probability table to generate a plurality of model parameters; and
a probability modeler constructing the conditional random field probability model according to the model parameters.

4. The web mimicry attack detection device of claim 1, wherein the first token sequence collector comprises:
a data variability reducer punching the string content of the hypertext transfer protocol request; and
a token sequence generator extracting the punched string content of the hypertext transfer protocol request according to the token collection method to generate the token sequence corresponding to the hypertext transfer protocol request.

5. The web mimicry attack detection device of claim 4, wherein the data variability reducer punches string content of the normal string data and the offensive string data by decoding strings, canceling repetitions and adding white space, and rewriting all letters of the string with lower case letters.

6. The web mimicry attack detection device of claim 1, wherein the label corresponding individually to the tokens is a normal or offensive classification name.

7. A web mimicry attack detection method, comprising:
constructing a conditional random field probability model;
receiving a hypertext transfer protocol request by a first token sequence collector,
extracting string content of the hypertext transfer protocol request according to a token collection method to generate a token sequence corresponding to the hypertext transfer protocol request, wherein the token sequence comprises a plurality of the tokens;
generating a label and a confidence score corresponding individually to the tokens according to the tokens and a conditional random field probability model;
summing the confidence score individually corresponding to the tokens in the token sequence by a summary rule to generate a summary confidence score; and
determining whether the hypertext transfer protocol request is an attack according to the summary confidence score and the label individually corresponding to the tokens.

8. The web mimicry attack detection method of claim 7, wherein the conditional random field probability model is generated by a token probability module.

9. The web mimicry attack detection method of claim 8, wherein step of constructing the conditional random field probability model comprises:
receiving normal string data and offensive string data;
extracting the normal string data and the offensive string data according to the token collection method to generate a normal token sequence corresponding to the normal string data and a offensive token sequence corresponding to the offensive string data;
calculating probabilities of adjacent token correlations in the normal token sequence and probabilities of adjacent token correlations in the offensive token sequence, and constructing an adjacent token correlation probability table to generate a plurality of model parameters; and
generating the conditional random field probability model according to the model parameters.

10. The web mimicry attack detection method of claim 7, further comprising:
punching the string content of the hypertext transfer protocol request.

11. The web mimicry attack detection method of claim 7, wherein step of generating the token sequence corresponding to the hypertext transfer protocol request comprises, according to a rule which is defined, wherein a token must be a the special symbol or a string composed of alphabets and digits, segmenting the hypertext transfer protocol request into the tokens from left to right and generating the token sequence according to locations of the tokens from left to right in the hypertext transfer protocol request.

12. The web mimicry attack detection method of claim 10, wherein step of punching the string content of the hypertext transfer protocol request is performed by decoding strings, canceling repetitions and adding white spaces, and rewriting all letters of the string with lower case letters.

13. The web mimicry attack detection method of claim 7, wherein the label corresponding individually to the tokens is a normal or offensive classification name.
